(19) United States
(12) Patent Application Publication
(10) Pub. No.: US 2025/0126053 A1
(43) Pub. Date: Apr. 17, 2025

(54) NETWORK ACCESS DEVICE, SYSTEM, AND COMMUNICATION METHOD

(71) Applicant: Hangzhou AliCloud Feitian Information Technology Co., Ltd., Hangzhou City (CN)

(72) Inventor: Zhen TAO, Hangzhou (CN)

(21) Appl. No.: 18/685,214

(22) PCT Filed: Jan. 31, 2023
(86) PCT No.: PCT/CN2023/073926

§ 371 Date: Feb. 20, 2024

(30) Foreign Application Priority Data
Feb. 9, 2022 (CN) 202210122845.2

(51) Int. Cl. H04L 45/24; H04W 40/12

(52) U.S. Cl. CPC H04L 45/245; H04W 40/12

(57) ABSTRACT

The embodiments of the present application provide a network access device, a system and a communication method. The network access device includes a processor and at least one communication interface for realizing detachable connection; the processor is connected with the at least one communication interface respectively; the processor is configured to: detect whether each communication interface in the at least one communication interface is detachably connected with an external cellular communication device; determine an available cellular communication device according to a detection result; establish, based on the available cellular communication device, an aggregation link for data transmission between the network access device and a target server. The solution provided in the embodiments of the present application can solve the problem that the aggregation device in the prior art has a single model and cannot meet different networking requirements of customers.

This application claims priority to Chinese Patent Application No. 202210122845.2, filed on Feb. 9, 2022 and entitled “NETWORK ACCESS DEVICE, SYSTEM, AND COMMUNICATION METHOD”. The afore-mentioned application is hereby incorporated by reference in its entirety.

### TECHNICAL FIELD

The present application relates to the field of communication technology and, in particular, to a network access device, a system, and a communication method.

### BACKGROUND

At present, high availability technology of cellular connection is a key research direction, and multi-link aggregation technology is an important sub-field of high availability technology of cellular connection.

A multi-link aggregation router based on multi-link aggregation technology can aggregate the bandwidth of multiple internet links, which can not only improve the bandwidth of uplink and downlink networks in a mobile environment, but also reduce the signal dead zone of mobile networks and improve network availability because a device supports the simultaneous use of SIM cards from different operators.

### SUMMARY

Embodiments of the present application provide a network access device, a system and a communication method, which are used to solve the problem that the aggregation device in the prior art has a single model and cannot meet different networking requirements of customers.

Therefore, an embodiment of the present application provides a network access device. The device includes a processor and at least one communication interface for realizing detachable connection; the processor is connected with the at least one communication interface respectively; the processor is configured to:
detect whether each communication interface in that at least one communication interface is detachably connected with an external cellular communication device;
determine an available cellular communication device according to a detection result; and
establish, based on the available cellular communication device, an aggregation link for data transmission between the network access device and a target server.

In another embodiment of the present application, a network access system is provided. The system includes:
the network access device and a cellular communication device for detachably connecting to the communication interface.

In yet another embodiment of the present application, a communication system is provided. The system includes:
a network access device including a processor and at least one communication interface for realizing detachable connection; the processor is connected with the at least one communication interface respectively; the processor is configure to detect whether each communication interface in the at least one communication interface is detachably connected with a cellular communication device; determine an available cellular communication device according to a detection result; establish, based on the available cellular communication device, an aggregation link for data transmission between the network access device and a target server;
the available cellular communication device; and
the target server.

In another embodiment of the present application, a communication method is provided, where the communication method is suitable for a network access device; the network access device includes at least one communication interface for realizing detachable connection; and the method includes:
detecting whether each communication interface in the at least one communication interface is detachably connected with an external cellular communication device;
determining an available cellular communication device according to a detection result; and
establishing, based on the available cellular communication device, an aggregation link for data transmission between the network access device and a target server.

In the technical solutions provided by the embodiments of the present application, a network access device is provided with several communication interfaces for detachable connection with external cellular communication devices. That is to say, there is no need for a built-in cellular communication module in the network access device, and only several communication interfaces for detachable connection of external cellular communication devices need to be reserved. In this way, by providing cellular communication devices with various network standards, it can be realized that one kind of network access device can meet different networking requirements of various customers in various occasions.

### BRIEF DESCRIPTION OF DRAWINGS

In order to explain the technical solutions in the embodiments of the present application or the prior art more clearly, the drawings needed to be used in the description of the embodiments or the prior art will be briefly introduced below. Apparently, the drawings described below are some of the embodiments of the present application, and other drawings can be acquired by a person of ordinary skill in the art based on these drawings without paying creative efforts.

FIG. 1 is a schematic diagram of the working principle of a multi-link aggregation server in the prior art.

FIG. 2 is a schematic structural diagram of a network access system according to an embodiment of the present application.

FIG. 3 is a schematic structural diagram of a network access device according to an embodiment of the present application.

FIG. 4 is a schematic flowchart of a communication method according to an embodiment of the present application.

FIG. 5 is a schematic structural diagram of a communication system according to an embodiment of the present application.

### DESCRIPTION OF EMBODIMENTS

At present, a multi-link aggregation router based on multi-link aggregation technology can aggregate the bandwidth of multiple internet links, which can not only improve the bandwidth of uplink and downlink networks in a mobile environment, but also reduce the signal dead zone of mobile networks and improve network availability because a device supports the simultaneous use of Subscriber Identity Module SIM (Subscriber Identity Module) cards from different operators.

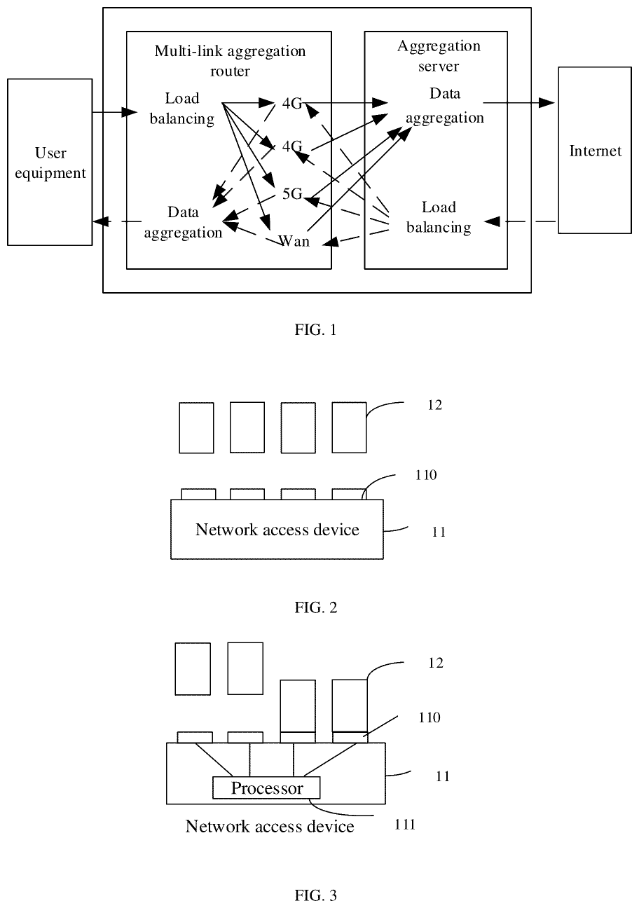

FIG. 1 illustrates the working principle of an existing multi-link aggregation router: an aggregation link is established between the multi-link aggregation router and an aggregation server, where the aggregation link includes a plurality of sub-links established based on a plurality of cellular networks and/or a wired network. The user equipment can transmit data to be uploaded to the multi-link aggregation router through a wifi network provided by the multi-link aggregation router, and the multi-link aggregation router distributes the data to be uploaded to the plurality of sub-links in the aggregation link according to a load balancing strategy or a distribution strategy; the aggregation server performs data aggregation on the data transmitted from the plurality of sub-links in the aggregation link to obtain the data to be uploaded, and transmits the data to be uploaded to the Internet. When the Internet needs to transmit data to be downloaded that is required by the user equipment to the user equipment, the Internet can transmit the data to be downloaded to the aggregation server; the aggregation server distributes the data to be downloaded to the plurality of sub-links in the aggregation link according to a load balancing strategy or a distribution strategy; the multi-link aggregation router performs data aggregation on the data transmitted from multiple sub-links to obtain the data to be downloaded and transmits the data to be downloaded to the user equipment.

However, at present, the multi-link aggregation routers on the market are expensive, single in model and poor in flexibility, and cannot flexibly meet the requirements of customers for various network standards and bandwidths.

In order to solve or partially solve the above problems, the embodiments of the present application proposes a new network access device, which is provided with several communication interfaces for detachable connection with external cellular communication devices. That is to say, there is no need for a built-in cellular communication module in the network access device, and only several communication interfaces for detachable connection with external cellular communication devices need to be reserved. In this way, by providing cellular communication devices with various network standards, it can be realized that one kind of network access device can meet different networking requirements of various customers in various occasions.

In order to make a person of ordinary skill in the art better understand the solutions of the present application, the technical solutions in the embodiments of the present application will be described clearly and comprehensively with reference to the accompanying drawings. Apparently, the described embodiments are merely a part rather than all of the embodiments of the present application. Other embodiments acquired by a person of ordinary skill in the art based on the embodiments of the present application without paying creative efforts shall fall within the scope of protection of the present application.

In addition, some processes described in the specification, claims and the above-mentioned drawings of the present application include a plurality of operations that appear in a specific order, and these operations may be performed out of the order in which they appear here or in parallel. The sequence numbers of operations, such as 101 and 102, are only used to distinguish different operations, and the sequence numbers themselves do not represent any execution order. In addition, these processes may include more or fewer operations, and these operations may be performed sequentially or in parallel. It should be noted that the descriptions of “first” and “second” herein are used to distinguish different messages, devices, modules, etc., and do not represent the sequence, nor do they limit that “first” and “second” are different types.

FIG. 2 illustrates a structural block diagram of a network access system according to an embodiment of the present application. The system includes a network access device 11 and a cellular communication device 12 for detachably connecting to a communication interface 110 on the network access device 11.

The number of the communication interface 110 on the network access device 11 may be at least one. The number of the cellular communication device 12 may be at least one. The number of the communication interface 110 on the network access device 11 and the number of the cellular communication device 12 may be the same or different, which is not specifically limited in this embodiment of the present application.

The above-mentioned network access device can provide network access function to a user terminal. The network access device may be an electronic device such as CPE (Customer Premise Equipment, customer premise equipment), a gateway device, a wireless router, etc., and can receive a cellular signal (also called a mobile signal) of a base station through the cellular communication device detachably connected thereto, and convert the cellular signal into a WIFI signal or an Ethernet signal. Of course, it can also accept a WIFI signal or a wired signal. The network access device can convert a high-speed 4G or 5G network signal into a WIFI signal or an Ethernet signal to communicate with a terminal, and can be widely used as a wireless network access device in rural areas, cities, hospitals, factories, communities, etc., which can greatly save the cost of laying network lines. Of course, the network access device can also access a cellular signal of 6G or a higher level, which is not limited in this embodiment.

The communication interface includes, but is not limited to, a USB (Universal Serial Bus, universal serial bus) interface, a lightning interface and a firewire interface. The cellular communication device is provided with a communication interface matched with the communication interface. In an instance, the communication interface may be a pluggable communication interface, such as a hot plug communication interface.

The cellular communication device includes a cellular communication module. The cellular communication module is configured to communicate with the base station. Specifically, the cellular communication module is configured to communicate with a subscriber identity card (SIM card) and the base station.

The concrete implementation of the above-mentioned network access device 11 and the cellular communication module 12 and the interaction process between them will be described in detail in the following embodiments.

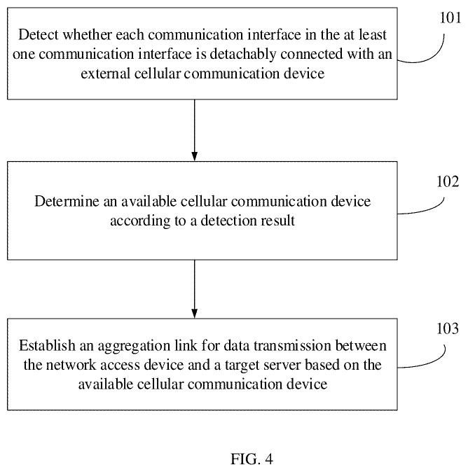

FIG. 3 illustrates a schematic structural diagram of a network access device according to an embodiment of the present application. The device 11 includes a processor 111 and at least one communication interface 110 for realizing detachable connection; the processor 111 is connected with the at least one communication interface 110 respectively. As shown in FIG. 4, the processor 111 is configured to perform the following operations:
101: detect whether each communication interface in the at least one communication interface is detachably connected with an external cellular communication device;
102: determine an available cellular communication device according to a detection result; and
103: establish, based on the available cellular communication device, an aggregation link for data transmission between the network access device and a target server.

In the above 101, the cellular communication device includes a cellular communication module. In an instance, the cellular communication device may further include a SIM card slot connected with the cellular communication module, and the SIM card slot is used for inserting an external SIM card. The connection between the SIM card slot and the cellular communication module may include communication connection and power connection. The cellular communication module supplies power to the SIM card inserted in the SIM card slot through the power connection. In practical application, a user may first insert the SIM card into the SIM card slot in the cellular communication device, and then detachably connect the cellular communication device to the communication interface of the network access device.

In another instance, the cellular communication device may further include a virtual SIM card or an embedded SIM card communicating with the cellular communication module. In this embodiment, the virtual SIM card or the embedded SIM card is integrated with the cellular communication device.

In the above two embodiments, the SIM card is provided on the side of the cellular communication device. Of course, the SIM card may also be provided on the side of the network access device. Specifically, the network access device is further provided with at least one SIM card slot, and the at least one SIM card slot is in one-to-one correspondence with the at least one communication interface, where each SIM card slot in the at least one SIM card slot is connected with a corresponding communication interface. In practical application, the SIM card inserted in the SIM card slot communicates with the cellular communication device connected with the communication interface opposite to the SIM card slot.

In the above 101, the at least one communication interface includes a first communication interface. The first communication interface is any one of the at least one communication interface.

In an achievable solution, whether the first communication interface is detachably connected with an external cellular communication device may be detected in the following way: the processor may transmit first detection information to the first communication interface at regular intervals, and if first response information corresponding to the first detection information is received through the first communication interface, it is determined that an external cellular communication device is detachably connected with the first communication interface. A corresponding relationship between the first detection information and the first response information may be pre-stored in the network access device.

In the above 102, according to the detection result of the above 101, a non-idle communication interface which is detachably connected with an external cellular communication device in the at least one communication interface can be determined, and the cellular communication device detachably connected with the non-idle communication interface is determined as an available cellular communication device.

The number of the above-mentioned non-idle communication interface may be at least one, which is one or more. Accordingly, the number of the available cellular communication device is at least one, which is one or more.

In the above 103, the aggregation link refers to a link formed by combining a plurality of sub-links established between the network access device and the target server. The aggregation link includes a first sub-link established between the network access device and the target server based on an available cellular communication device, that is, the plurality of sub-links include the first sub-link. The first sub-link is established based on the cellular network accessed by the available cellular communication device.

The number of the available cellular communication device may be at least one, and accordingly, the aggregation link includes a first sub-link established between the network access device and the target server based on each cellular communication device in at least one cellular communication device. When the number of the available cellular communication device is one, the number of the first sub-link is one; when the number of the available cellular communication device is multiple, the number of the first sub-link is multiple.

In practical application, the aggregation link (or the multiple sub-links) may include not only the first sub-link, but also a second sub-link established between the network access device and the target server based on a wired communication module on the network access device, where the wired communication module is used for providing communication based on a wired network for the network access device. Specifically, the network access device is further provided with a wired wide area network interface; the wired wide area network interface is connected with the wired communication module, and when the wired wide area network interface is plugged with a network cable of a wired network, the wired communication module can provide communication based on the wired network for the network access device. That is, the second sub-link is based on the wired network accessed by the wired communication module.

In an achievable solution, the network access device may further include a wired wide area network interface. The processor is further configured to:
A, detect whether the wired wide area network interface is connected with a wired network.
B, establish, based on the available cellular communication device and the wired network, an aggregation link for data transmission between the network access device and the target server when it is detected that the wired wide area network interface is connected with a wired network.

That is, the first sub-link is established based on the cellular network accessed by the cellular communication device, and the second sub-link is established based on the wired network.

In the above 103, “establish, based on the available cellular communication device, a first sub-link for data transmission between the network access device and the target server” is specifically: transmit a link establishment request to the available cellular communication device; the available cellular communication device transmits the link establishment request to the target server through the cellular network that it accesses, so as to establish the first sub-link between the network access device and the target server. In practical application, after the link establishment request is received, the target server may return a link establishment response message to the cellular communication device, and the cellular communication device transmits the link establishment response message to the processor, thus completing the establishment of the first sub-link.

In an instance, the available cellular communication device can automatically perform the operation of accessing the cellular network after detecting that it is detachably connected with the communication interface of the network access device. The specific access process may include: cell search, system information transmission and random access, etc. The specific implementation process of each stage can be found in the prior art and will not be described in detail here.

In another instance, the processor may transmit a network access request to the available cellular communication device; and the available cellular communication device performs the operation of accessing the cellular network after receiving the network access request.

It should be supplemented that the target server may be a service node in a content distribution network; and after startup, the network access device may transmit an aggregate link request to a scheduling center in the content distribution network. After the aggregation link request is received, the scheduling center selects a service node from the content distribution network as the target server according to a preset scheduling strategy, and transmits address information of the target server, such as the IP address, to the network access device. The network access device can subsequently establish an aggregation link with the target server according to the address information of the target server.

Of course, the address information of the target server may be stored in the network access device in advance, for example, the address information of the target server may be configured in a memory of the network access device by default before leaving the factory.

In the technical solution according to the embodiment of the present application, the network access device is provided with several communication interfaces for detachable connection with external cellular communication devices. That is to say, there is no need for a built-in cellular communication module in the network access device, and only several communication interfaces for detachable connection with external cellular communication devices need to be reserved. In this way, by providing cellular communication devices with various network standards, it can be realized that one kind of network access device can meet the different networking requirements of various customers in various occasions.

Optionally, the processor is further configured to:
104: generate a list of the available cellular communication device according to the available cellular communication device; and
105: distribute data to be transmitted to each available cellular communication device recorded in the list of the available cellular communication device when the data to be transmitted is received from a terminal device, for transmission to the target server by each available cellular communication device through the aggregation link between the network access device and the target server.

In the above 104, the list of the available cellular communication device may record device information of the available cellular communication device and/or interface information of the communication interface to which the available cellular communication device is connected. The device information is used to uniquely identify the corresponding available cellular communication device; the interface information is used to uniquely identify the corresponding communication interface. The device information may include, but is not limited to, name and identification information. The interface information may include an interface number. For example, the network access device is provided with three communication interfaces, which may be numbered in advance, such as number 1, number 2and number 3.

In the above 105, when the data to be transmitted is received from the terminal device, the data to be transmitted may be distributed to each available cellular communication device recorded in the list of the available cellular communication device, so that each available cellular communication device transmits the data the available cellular communication device is responsible for transmission to the target server through the respective corresponding first sub-link in the aggregation link.

In an instance, a plurality of available cellular communication devices are recorded in the list of the available cellular communication device, and the data to be transmitted may be distributed to the plurality of available cellular communication devices recorded in the list of the available cellular communication device, so that the plurality of available cellular communication devices transmits the data the plurality of available cellular communication devices are respectively responsible for transmission to the target server through the respective corresponding first sub-links in the aggregation link.

In another instance, at least one available cellular communication device is recorded in the list of the available cellular communication device. In addition, the network access device is further provided with a wired communication module, where the wired communication module has been connected to the wired network. The data to be transmitted may be distributed to the at least one available cellular communication device recorded in the list of the available cellular communication device and the wired communication module provided on the network access device, so that each available cellular communication device transmits the data the available cellular communication device is responsible for transmission to the target server through the respective corresponding first sub-link in the aggregation link, and the wired communication module transmits the data the wired communication module is responsible for transmission to the target server through the second sub-link in the aggregation link.

In practical application, the user can insert a new cellular communication device into an idle communication interface on the network access device at any time according to actual needs, so as to increase the overall bandwidth of the aggregation link. Specifically, the processor is further configured to:
106: determine an idle communication interface from the at least one communication interface according to the list of the available cellular communication device;
107: when it is detected that the idle communication interface is detachably connected with an external cellular communication device, update the aggregation link between the network access device and the target server based on the cellular communication device detachably connected with the idle communication interface; and
108: update the list of the available cellular communication device according to the cellular communication device detachably connected with the idle communication interface.

In the above 106, in an instance, interface information of a communication interface to which an available cellular communication device is connected is recorded in the list of the available cellular communication device. Therefore, according to the interface information of the communication interface to which the available cellular communication device is connected recorded in the list of the available cellular communication device, a non-idle communication interface and an idle communication interface can be determined from the at least one communication interface.

In the above 107, when it is detected that the idle communication interface is detachably connected with an external cellular communication device, it means that a new cellular communication device is connected with the idle communication interface, so it is necessary to update the aggregation link between the network access device and the target server based on the cellular communication device detachably connected with the idle communication interface. Specifically, the aggregation link between the network access device and the target server is updated based on the cellular communication device recorded in the list of the available cellular communication device and the cellular communication device detachably connected with the idle communication interface.

In an achievable solution, a new first sub-link may be established between the network access device and the target server based on the cellular communication device detachably connected with the idle communication interface, which is equivalent to adding a new first sub-link in the aggregation link between the network access device and the target server, and the original sub-link in the aggregation link remains unchanged.

In the above 108, a relevant record of the cellular communication device detachably connected with the idle communication interface may be added to the list of the available cellular communication device, for example, device information of the cellular communication device detachably connected with the idle communication interface and/or interface information of the idle communication interface may be added to the list of the available cellular communication device.

In this way, when there is new data to be transmitted later, the processor of the network access device performs data distribution or load balancing according to the updated list of the available cellular communication device, so as to ensure that the newly added cellular communication device can realize data transmission.

Optionally, the processor is further configured to:
109: determine a non-idle communication interface from the at least one communication interface; and
110: update the list of the available cellular communication device when it is detected that the cellular communication device detachably connected with the non-idle communication interface has been detached.

When it is detected that the cellular communication device detachably connected with the non-idle communication interface has been detached, the record about the detached cellular communication device may be deleted in the list of the available cellular communication device, for example, the device information of the detached cellular communication device and/or the interface information of the non-idle communication interface may be deleted; alternatively, the record about the detached cellular communication device may be marked as detached in the list of the available cellular communication device.

In this way, when there is new data to be transmitted later, the processor of the network access device performs data distribution or load balancing according to the updated list of the available cellular communication device, so as to avoid the problem of data loss caused by distributing the data to the detached cellular communication device.

In an instance, “distribute data to be transmitted to each available cellular communication device recorded in the list of the available cellular communication device when the data to be transmitted is received from a terminal device, for transmission to the target server by each available cellular communication device through the aggregation link between the network access device and the target server” in the above 105 may be specifically implemented by adopting the following steps:
1051: acquire a link quality of a first sub-link corresponding to each available cellular communication device recorded in the list of the available cellular communication device when the data to be transmitted is received from the terminal device; and
1052: distribute, according to the link quality, the data to be transmitted to each available cellular communication device recorded in the list of the available cellular communication device.

The aggregation link between the network access device and the target server includes the sub-link corresponding to the available cellular communication device recorded in the list of the available cellular communication device.

In the above 1051, in practical application, a network speed V of the first sub-link corresponding to each available cellular communication device recorded in the list of the available cellular communication device may be acquired by adopting a network speed measurement algorithm test; a network delay T of the first sub-link corresponding to each available cellular communication device recorded in the list of the available cellular communication device may be acquired by adopting a network delay algorithm test; and/or, a network jitter D of the first sub-link corresponding to each available cellular communication device recorded in the list of the available cellular communication device may be acquired by adopting a network jitter algorithm test.

A network quality Q of the first sub-link corresponding to each available cellular communication device recorded in the list of the available cellular communication device may be determined according to the network speed V, the network delay T and/or the network jitter D of the first sub-link corresponding to each available cellular communication device recorded in the list of the available cellular communication device.

In an achievable solution, the network quality Q of the first sub-link corresponding to each available cellular communication device recorded in the list of the available cellular communication device may be determined according to the network speed V, the network delay T and the network jitter D of the first sub-link corresponding to each available cellular communication device recorded in the list of the available cellular communication device.

For example, Q=xV+yT+zD, where the sum of x, y and z is 1. The specific numerical values of x, y and z may be set according to actual needs, which is not specifically limited in the embodiment of the present application.

In the above 1052, in an instance, the transmission amount allocated to the first sub-link corresponding to each available cellular communication device is determined according to the link quality and the total amount of data to be transmitted, where the better the link quality, the greater the allocated transmission amount. The data to be transmitted is distributed to each available cellular communication device recorded in the list of the available cellular communication device according to the transmission amount allocated to the first sub-link corresponding to each available cellular communication device.

Considering the practical application, users are likely to use two or more SIM cards of the same operator at the same time. If the cellular communication devices connected with these two or more SIM cards independently select the cell to be accessed, there will be a problem that the cell with the strongest signal scanned by the cellular communication devices connected with the two or more SIM cards of the same operator in the same place is usually the same, that is, the cellular communication devices connected with the two or more SIM cards of the same operator will access the same cell after selecting preferentially, that is, the cellular communication devices connected with the two or more SIM cards of the same operator will access the same base station. Once this base station fails, the whole network access device will not be able to provide network access for terminal users, and the availability or reliability will be poor.

In order to improve the availability or reliability, the processor in the network access device may decide which cell each cellular communication device accesses, so that the cellular communication devices connected with the two or more SIM cards of the same operator can be actively connected to different base stations of the same operator in a decentralized manner. In this way, when one of the base stations fails, the network access device can still improve the network access capability for the user terminal based on other base stations, which ensures the reliability of communication. Specifically, there are a plurality of available cellular communication devices; and the processor is further configured to:
111: acquire a wireless network standard supported by each available cellular communication device in the plurality of available cellular communication devices and operator information supported by a subscriber identity card communicatively connected with each available cellular communication device, as a first acquisition result;
112: acquire cell information of an available cell obtained through scanning by each available cellular communication device in the plurality of available cellular communication devices, as a second acquisition result;
113: determine, according to the first acquisition result and the second acquisition result, cell access indication information of each available cellular communication device in the plurality of available cellular communication devices; and
114: send the cell access indication information of each available cellular communication device in the plurality of the available cellular communication devices to the corresponding available cellular communication device, so that each available cellular communication device accesses the corresponding cell according to the received cell access indication information.

In the above 111, the wireless network standard refers to the type of the wireless network, which may include, but is not limited to: 2G, 3G, 4G, 5G, Cat1 and Cat4. The operator information may include, but is not limited to: China Mobile, China Telecom and China Mobile. Different cellular communication devices may support different wireless network standards, and similarly, different subscriber identity cards (SIM cards) may support different operator information.

In an instance, the operator information supported by different cellular communication devices may be different, so in the above 111, the operator information supported by each available cellular communication device may further be acquired.

In the above 112, a scan command may be sent to each available cellular communication device in the plurality of available cellular communication devices, so that each available cellular communication device can acquire cell information of an available cell through scanning; each available cellular communication device acquires the cell information of the available cell through scanning and then transmits it to the processor of the network access device.

The cell information may include but is not limited to: base station information, wireless network standard, effective band (Band) and operator information.

In the above 113, cell access indication information of each available cellular communication device in the plurality of available cellular communication devices is determined according to the first acquisition result and the second acquisition result.

Specifically, it is determined whether there are two or more SIM cards belonging to the same operator according to the operator information supported by the subscriber identity card that each available cellular communication device in the plurality of available cellular communication devices is connected with. If there are two or more SIM cards belonging to the same operator, the target cell of the available cellular communication device connected with each SIM card in the two or more SIM cards is determined according to the wireless network standards supported by the available cellular communication devices connected with the two or more SIM cards and the cell information of the available cells obtained through scanning; the cell access indication information of the available cellular communication device connected with each SIM card in the two or more SIM cards is determined according to the cell information of the target cell of the available cellular communication device connected with each SIM card in the two or more SIM cards. The cell access indication information includes the cell information of the target cell, where the cell information of the target cell is used to instruct the corresponding available cellular communication device to access the target cell. The cell access indication information of the available cellular communication device connected with each SIM card of the two or more SIM cards is used to instruct the available cellular communication devices connected with the two or more SIM cards to access different cells, and the base stations corresponding to the different cells are different.

For example, the plurality of available cellular communication devices include a first available cellular communication device and a second available cellular communication device, the SIM cards connected with the first available cellular communication device and the second available cellular communication device belong to China Mobile. The wireless network standards supported by the first available cellular communication device are 4G and 5G, and the available cells obtained through scanning are: 4G cell of China Mobile and 5G cell of China Mobile. The wireless network standard supported by the second available cellular communication device is 4G, and the available cells obtained through scanning are: 4G cell of China Mobile and 5G cell of China Mobile. Therefore, it can be determined that the cell access indication information of the second available cellular communication device is used to instruct the second available cellular communication device to access the 4G cell of China Mobile and the cell access indication information of the first available cellular communication device is used to instruct the first available cellular communication device to access the 5G cell of China Mobile.

For another example, the plurality of available cellular communication devices include a first available cellular communication device and a second available cellular communication device, the SIM cards connected with the first available cellular communication device and the second available cellular communication device belong to China Mobile. The wireless network standards supported by the first available cellular communication device are 4G and 5G, and the available cells obtained through scanning are: 4G cell of China Mobile and 5G cell of China Mobile. The wireless network standards supported by the second available cellular communication device are 4G and 5G, and the available cell obtained through scanning is: 5G cell of China Mobile. Therefore, it can be determined that the cell access indication information of the second available cellular communication device is used to instruct the second available cellular communication device to access the 5G cell of China Mobile, and the cell access indication information of the first available cellular communication device is used to instruct the first available cellular communication device to access the 4G cell of China Mobile.

In practical application, if there is a SIM card belonging to only one operator in the SIM cards connected with the plurality of available cellular communication devices, the available cell with the strongest signal in the available cells obtained through scanning by the available cellular communication device connected with the SIM card belonging to only one operator may be determined as the target cell corresponding to the available cellular communication device.

In the above 114, the cell access indication information of each available cellular communication device of the plurality of available cellular communication devices is sent to the corresponding available cellular communication device, so that each available cellular communication device accesses the corresponding cell according to the received cell access indication information. Each available cellular communication device accesses the target cell indicated by the cell access indication information according to the received cell access indication information.

That is to say, in the embodiment of the present application, the processor of the network access device makes the overall decision on the cell that each available cellular communication device needs to access, instead of deciding by each available cellular communication device itself. By adopting the solution provided in the embodiment of the present application, the plurality of cellular communication devices can be actively and dispersedly connected with different cells, namely different base stations.

Further, in an achievable solution, in the above 107, “update the aggregation link between the network access device and the target server based on the cellular communication device detachably connected with the idle communication interface” may be implemented by adopting the following steps:
1071: acquire a wireless network standard supported by each cellular communication device in the cellular communication device recorded in the list of the available cellular communication device and the cellular communication device detachably connected with the idle communication interface, and operator information supported by the subscriber identity card communicatively connected with each cellular communication device, as a third acquisition result;
1072: acquire cell information of an available cell obtained through scanning by each cellular communication device in the cellular communication device recorded in the list of the available cellular communication device and the cellular communication devices detachably connected with the idle communication interface, as a fourth acquisition result;
1073: re-determine, according to the third acquisition result and the fourth acquisition result, the cell access indication information of each cellular communication device in the cellular communication device recorded in the list of the available cellular communication device and the cellular communication device detachably connected with the idle communication interface; and
1074: send the re-determined cell access indication information of each cellular communication device in the cellular communication device recorded in the list of the available cellular communication device and the cellular communication device detachably connected with the idle communication interface to the corresponding cellular communication device, so that each cellular communication device accesses the corresponding cell according to the received cell access indication information.

The specific implementation of the above 1071, 1072, 1073 and 1074 may refer to the corresponding contents in the above-mentioned embodiments, which will not be repeated here.

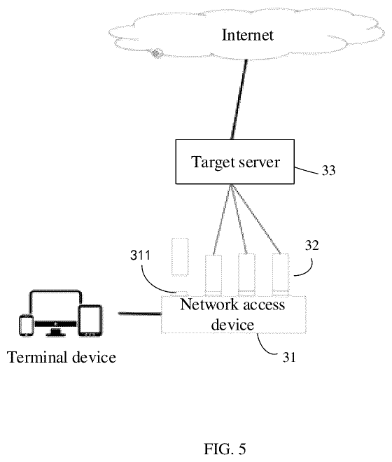

FIG. 5 illustrates a schematic diagram of a communication system according to an embodiment of the present application. As shown in FIG. 5, the communication system includes a network access device 31 including a processor and at least one communication interface for realizing detachable connection; the processor is connected with the at least one communication interface respectively; the processor is configured to detect whether each communication interface in the at least one communication interface is detachably connected with a cellular communication device; determine an available cellular communication device 32 according to a detection result; and establish, based on the available cellular communication device 32, an aggregation link for data transmission between the network access device 31 and a target server 33; the available cellular communication device 32; the target server 33.

In the technical solution provided in the embodiment of the present application, the network access device is provided with several communication interfaces for detachable connection with external cellular communication devices. That is to say, there is no need for a built-in cellular communication module in the network access device, and only several communication interfaces for detachable connection of external cellular communication devices need to be reserved. In this way, by providing cellular communication devices with various network standards, it can be realized that one kind of network access device can meet different networking requirements of various customers in various occasions.

In an instance, the network access device 31 may further include a wired wide area network interface. In this way, the network access device 31 may be connected with a wired network through the wired wide area network interface, and a second sub-link may be established between the network access device and the target server through the wired network. Related contents may refer to the corresponding contents in the above embodiments, which will not be repeated here.

What needs to be explained here is that the details of the specific implementation of each unit in the system provided in the embodiment of the present application may refer to the corresponding contents in the above embodiments, which will not be repeated here.

FIG. 4 illustrates a schematic flowchart of a communication method according to an embodiment of the present application. The method is suitable for the network access device; the network access device includes at least one communication interface for realizing detachable connection. As shown in FIG. 4, the method includes:
101: detect whether each communication interface in the at least one communication interface is detachably connected with an external cellular communication device;
102: determine an available cellular communication device according to a detection result; and
103: establish, based on the available cellular communication device, an aggregation link for data transmission between the network access device and a target server.

The specific implementation process of the above 101, 102 and 103 may refer to the corresponding contents in the above embodiments, and will not be repeated here.

In the technical solution provided in the embodiment of the present application, the network access device is provided with several communication interfaces for detachable connection with external cellular communication devices. That is to say, there is no need for a built-in cellular communication module in the network access device, and only several communication interfaces for detachable connection with external cellular communication devices need to be reserved. In this way, by providing cellular communication devices with various network standards, it can be realized that one kind of network access device can meet the different networking requirements of various customers in various occasions.

What needs to be explained here is that the details of each step in the method provided in the embodiment of the present application may refer to the corresponding contents in the above embodiments, which will not be repeated here. In addition, in addition to the above-mentioned steps, the method provided in the embodiment of the present application may further include other parts or all of the steps in the above-mentioned embodiments. Details may refer to the corresponding contents of the above-mentioned embodiments, which will not be repeated here.

The solution provided in the embodiment is suitable for live streaming scenarios, such as exhibition live streaming, outdoor live streaming, business live streaming. The network access device can provide a wifi network for one or more live streaming terminals. The live streaming terminals in the embodiment may be any device capable of live streaming, such as a mobile phone, a tablet computer, which is not limited in the embodiment of the present application.

The solution provided in the embodiment is also suitable for intelligent driving or assisted driving scenarios. The above network access device may be installed on a vehicle.

The solution provided in the embodiment is also suitable for remote consultation scenarios, and a diagnostic device can access the wifi network or Ethernet provided by the network access device.

Introduction will be made below by taking the live streaming scenarios as an example with reference to FIG. 5.

As shown in FIG. 5, the network access device 31 is provided with four USB interfaces 311, among which three USB interfaces 311 are connected with the cellular communication devices 32. After the network access device 31 is started, a first sub-link is established between the network access device 31 and the target server 33 through the cellular network accessed by the cellular communication device 32 connected with each USB interface 311 of the three USB interfaces 311, to acquire three first sub-links; the three first sub-links constitute the aggregation link between the network access device 31 and the target server 33.

The live streaming terminal (that is, the terminal device in FIG. 5) sends video data to be uploaded to the network access device 31 through the wifi network provided by the network access device 31, and the network access device 31 distributes the video data to be uploaded to a plurality of first sub-links for uploading to the target server. The target server aggregates data transmitted from the plurality of first sub-links to acquire the video data to be uploaded; the target server sends the aggregated video data to be uploaded to a video server (the Internet in FIG. 5 includes the video server).

In conclusion, it is realized that one kind of router can meet different networking requirements of various customers by making a unified pluggable cellular connection module and its switching control logic with wireless network standards such as Cat1/Cat4/5G. By automatically configuring the target cell corresponding to each cellular communication module through the network access device, different connections under the same operator can be effectively dispersed to different base stations to enhance high availability.

The device embodiments described above are only schematic, in which the units described as separate components may or may not be physically separated, and the components displayed as units may or may not be physical units, that is, they may be located in one place or distributed to multiple network units. Some or all of the modules may be selected according to actual needs to achieve the purpose of the embodiment. A person of ordinary skill in the art can understand and implement it without paying creative efforts.

From the description of the above embodiments, a person skilled in the art can clearly understand that each embodiment may be implemented by means of software and necessary general hardware platform, and of course it may also be implemented by hardware. Based on this understanding, the essence of the above technical solutions or the part that has contributed to the prior art can be embodied in the form of a software product, which may be stored in a computer-readable storage medium, such as a ROM/RAM, a magnetic disk, an optical disk, and includes several instructions for causing a computer device (which may be a personal computer, a server, or a network device, etc.) to perform the method described in various embodiments or some parts of the embodiments.

Finally, it should be explained that the above embodiments are only used to illustrate the technical solution of the present application, but not to limit it; although the present application has been described in detail with reference to the foregoing embodiments, it should be understood that a person skilled in the art can still make modifications to the technical solutions described in the foregoing embodiments or replace some technical features with equivalents; however, these modifications and replacements do not make the essence of the corresponding technical solutions depart from the spirit and scope of the technical solutions of various embodiments of the present application.

1. A network access device, comprising: a processor and at least one communication interface for realizing detachable connection; the processor is connected with the at least one communication interface respectively; the processor is configured to:
detect whether each communication interface in the at least one communication interface is detachably connected with an external cellular communication device;
determine an available cellular communication device according to a detection result; and
establish, based on the available cellular communication device, an aggregation link for data transmission between the network access device and a target server.

2. The network access device according to claim 1, wherein the processor is further configured to:
generate a list of the available cellular communication device according to the available cellular communication device; and
distribute data to be transmitted to each available cellular communication device recorded in the list of the available cellular communication device when the data to be transmitted is received from a terminal device, for transmission to the target server by each available cellular communication device through the aggregation link between the network access device and the target server.

3. The network access device according to claim 2, wherein the processor is further configured to:
determine an idle communication interface from the at least one communication interface according to the list of the available cellular communication device;
when it is detected that the idle communication interface is detachably connected with an external cellular communication device, update the aggregation link between the network access device and the target server based on the cellular communication device detachably connected with the idle communication interface; and
update the list of the available cellular communication device according to the cellular communication device detachably connected with the idle communication interface.

4. The network access device according to claim 2, wherein the processor is further configured to:
determine, according to the list of the available cellular communication device, a non-idle communication interface from the at least one communication interface; and
update the list of the available cellular communication device when it is detected that a cellular communication device detachably connected with the non-idle communication interface has been detached.

5. The network access device according to claim 2, wherein the processor is specifically configured to:
acquire a link quality of a first sub-link corresponding to each available cellular communication device recorded in the list of the available cellular communication device when the data to be transmitted is received from the terminal device; and
distribute, according to the link quality, the data to be transmitted to each available cellular communication device recorded in the list of the available cellular communication device;
wherein the aggregation link between the network access device and the target server comprises the first sub-link corresponding to each available cellular communication device recorded in the list of the available cellular communication device.

6. The network access device according to claim 1, wherein there are a plurality of available cellular communication devices;
the processor is further configured to:
acquire a wireless network standard supported by each available cellular communication device in the plurality of available cellular communication devices and operator information supported by a subscriber identity card communicatively connected with each available cellular communication device, as a first acquisition result;
acquire cell information of an available cell obtained through scanning by each available cellular communication device in the plurality of available cellular communication devices, as a second acquisition result;
determine, according to the first acquisition result and the second acquisition result, cell access indication information of each available cellular communication device in the plurality of available cellular communication devices; and
send the cell access indication information of each available cellular communication device in the plurality of the available cellular communication devices to the corresponding available cellular communication device, so that each available cellular communication device accesses the corresponding cell according to the received cell access indication information.

7. The network access device according to claim 6, wherein the cell access indication information comprises cell information of a target cell;
wherein the cell information of the target cell is used to instruct the corresponding available cellular communication device to access the target cell.

8. The network access device according to claim 1, wherein the communication interface comprises a universal serial bus interface, a lightning interface or a firewire interface.

9. The network access device according to claim 1, further comprising: a wired wide area network interface;
wherein it is detected whether the wired wide area network interface is connected with a wired network;
the processor is specifically configured to:
establish, based on the available cellular communication device and the wired network, an aggregation link for data transmission between the network access device and the target server when it is detected that the wired wide area network interface is connected with a wired network.

10. A network access system, comprising the network access device according to claim 1 and a cellular communication device for detachably connecting to the communication interface.

11. A communication system, comprising:
a network access device comprising a processor and at least one communication interface for realizing detachable connection; the processor is connected with the at least one communication interface respectively; the processor is configured to detect whether each communication interface in the at least one communication interface is detachably connected with a cellular communication device; determine an available cellular communication device according to a detection result; and establish, based on the available cellular communication device, an aggregation link for data transmission between the network access device and a target server;
the available cellular communication device; and
the target server.

12. A communication method, which is suitable for a network access device; wherein the network access device comprises at least one communication interface for realizing detachable connection; and the method comprises:
detecting whether each communication interface in the at least one communication interface is detachably connected with an external cellular communication device;
determining an available cellular communication device according to a detection result; and
establishing, based on the available cellular communication device, an aggregation link for data transmission between the network access device and a target server.

13. The network access device according to claim 3, wherein the processor is specifically configured to:
acquire a link quality of a first sub-link corresponding to each available cellular communication device recorded in the list of the available cellular communication device when the data to be transmitted is received from the terminal device; and
distribute, according to the link quality, the data to be transmitted to each available cellular communication device recorded in the list of the available cellular communication device;
wherein the aggregation link between the network access device and the target server comprises the first sub-link corresponding to each available cellular communication device recorded in the list of the available cellular communication device.

14. The communication system according to claim 11, wherein the processor is further configured to:
generate a list of the available cellular communication device according to the available cellular communication device; and
distribute data to be transmitted to each available cellular communication device recorded in the list of the available cellular communication device when the data to be transmitted is received from a terminal device, for transmission to the target server by each available cellular communication device through the aggregation link between the network access device and the target server.

15. The communication system according to claim 14, wherein the processor is further configured to:
determine an idle communication interface from the at least one communication interface according to the list of the available cellular communication device;
when it is detected that the idle communication interface is detachably connected with an external cellular communication device, update the aggregation link between the network access device and the target server based on the cellular communication device detachably connected with the idle communication interface; and
update the list of the available cellular communication device according to the cellular communication device detachably connected with the idle communication interface.

16. The communication system according to claim 14, wherein the processor is further configured to:
determine, according to the list of the available cellular communication device, a non-idle communication interface from the at least one communication interface; and
update the list of the available cellular communication device when it is detected that a cellular communication device detachably connected with the non-idle communication interface has been detached.

17. The communication method according to claim 12, wherein the method further comprises:
generating a list of the available cellular communication device according to the available cellular communication device; and
distributing data to be transmitted to each available cellular communication device recorded in the list of the available cellular communication device when the data to be transmitted is received from a terminal device, for transmission to the target server by each available cellular communication device through the aggregation link between the network access device and the target server.

18. The communication method according to claim 17, wherein the method further comprises:
determining an idle communication interface from the at least one communication interface according to the list of the available cellular communication device;
when it is detected that the idle communication interface is detachably connected with an external cellular communication device, updating the aggregation link between the network Preliminary Amendment access device and the target server based on the cellular communication device detachably connected with the idle communication interface; and
updating the list of the available cellular communication device according to the cellular communication device detachably connected with the idle communication interface.

19. The communication method according to claim 17, wherein the method further comprises:
determining, according to the list of the available cellular communication device, a non-idle communication interface from the at least one communication interface; and
updating the list of the available cellular communication device when it is detected that a cellular communication device detachably connected with the non-idle communication interface has been detached.

20. A non-transitory computer storage medium storing a computer program, and when the computer program is executed by a computer, the communication method according to claim 12 is implemented.
